(19) United States
(12) Patent Application Publication
(10) Pub. No.: US 2013/0098190 A1
(43) Pub. Date: Apr. 25, 2013

(54) MECHANICAL MANIPULATOR WITH CABLE PROTECTION STRUCTURE

(71) Applicant: XIAO-PENG PAN, Shenzhen City (CN)

(72) Inventor: XIAO-PENG PAN, Shenzhen City (CN)

(73) Assignees: HON HAI PRECISION INDUSTRY CO., LTD., Tu-Cheng, New Taipei (TW); Hong Fu Jin Precision Industry (ShenZhen) Co., Ltd., Shenzhen City (CN)

(21) Appl. No.: 13/534,393

(22) Filed: Jun. 27, 2012

(30) Foreign Application Priority Data
Oct. 21, 2011 (CN) 201110322686.2

(51) Int. Cl. B25J 19/06

(52) U.S. Cl. 74/490.02; 901/49

(57) ABSTRACT

A mechanical manipulator includes a base seat, a connecting arm, a mechanical arm, an electric cable, and a cable protection structure. The connecting arm has a first end rotatably hinged to the base seat, a second end opposite to the first end, and a side surface, the connecting arm defines a cable receiving slot in the side surface. The mechanical arm is rotatably hinged to the second end of the connecting arm. The electric cable is partially received within the cable receiving slot. Two ends of the electric cable are exposed from two ends of the cable receiving slot and then enter into the base seat and the mechanical arm respectively. The cable protection structure is fixed to the connecting arm and resists against the electric cable toward the cable receiving slot, for preventing the electric cable emerging from the cable receiving slot.

### BACKGROUND

1. Technical Field

The present disclosure generally relates to mechanical manipulators, and particularly to a mechanical manipulator with cable protection structure.

2. Description of Related Art

Mechanical manipulator is a kind of automatic operating device capable of grasping and moving workpieces according to a preset controlling program. The mechanical manipulator generally includes a plurality of electric cables coiling around the mechanical manipulator, and electrically connected to an outer controlling electric power or an electric motor for transmitting electric signals or control signals. In use, the mechanical manipulator is driven to move continuously, thus, the electric cables are worn out easily.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 shows an isometric view of an embodiment of a mechanical manipulator.

FIG. 2 shows a partial assembled isometric view of the mechanical manipulator of FIG. 1.

FIG. 3 shows a partial exploded isometric view of the mechanical manipulator of FIG. 2.

FIG. 4 shows an isometric view of a first positioning mechanism of the cable protection structure of FIG. 1.

FIG. 5 shows an isometric view of a second positioning mechanism of the cable protection structure of FIG. 2.

FIG. 6 shows an assembled isometric view of the electric cable and the cable protection structure of FIG. 3.

### DETAILED DESCRIPTION

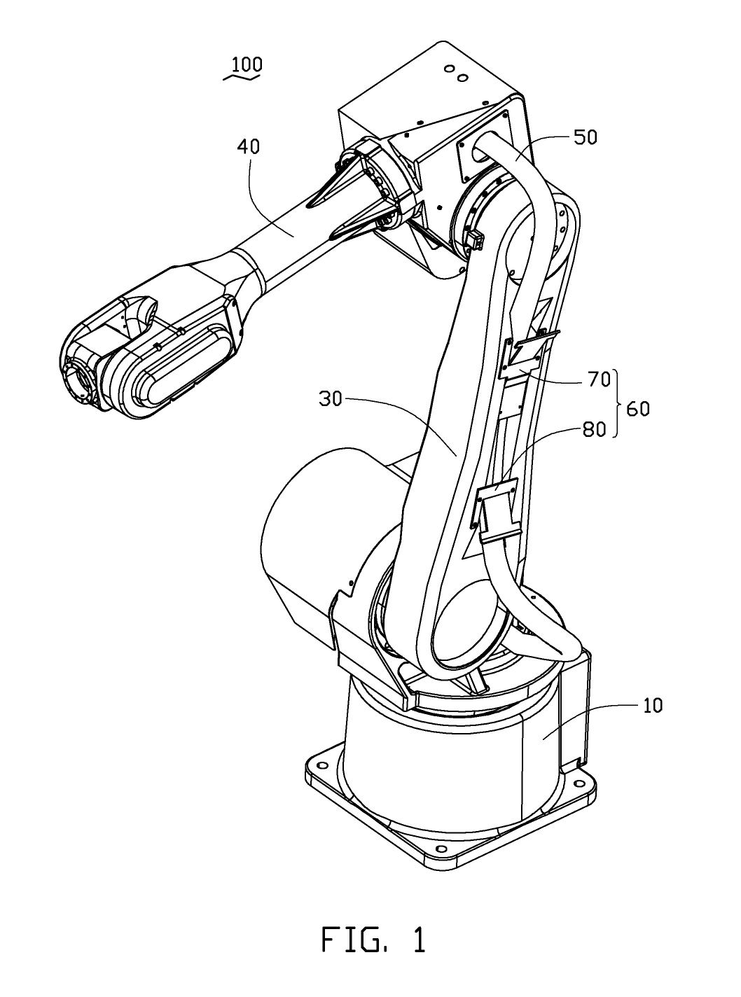

Referring to FIG. 1, an isometric view of an embodiment of a mechanical manipulator 100 is shown. The mechanical manipulator 100 includes a base seat 10, a connecting arm 30, a mechanical arm 40, an electric cable 50, and a cable protection structure 60. A first end of the connecting arm 30 is rotatably hinged to the base seat 10. The mechanical arm 40 is rotatably hinged to a second end of the connecting arm 30 opposite to the first end of the connecting arm 30. The electric cable 50 is partially assembled within the connecting arm 30 via the cable protection structure 60. Two ends of the electric cable 50 respectively exit from the two ends of the connecting arm 30, and enter the base seat 10 and the mechanical arm 40, respectively. In the illustrated embodiment, the base seat 10 may include a driving motor (not shown) assembled within the base seat 10, the mechanical arm 40 may include a driving module (not shown) assembled within the mechanical arm 40, such that, the two ends of the electric cable 50 are electrically connected with the corresponding driving motor and the driving module, respectively.

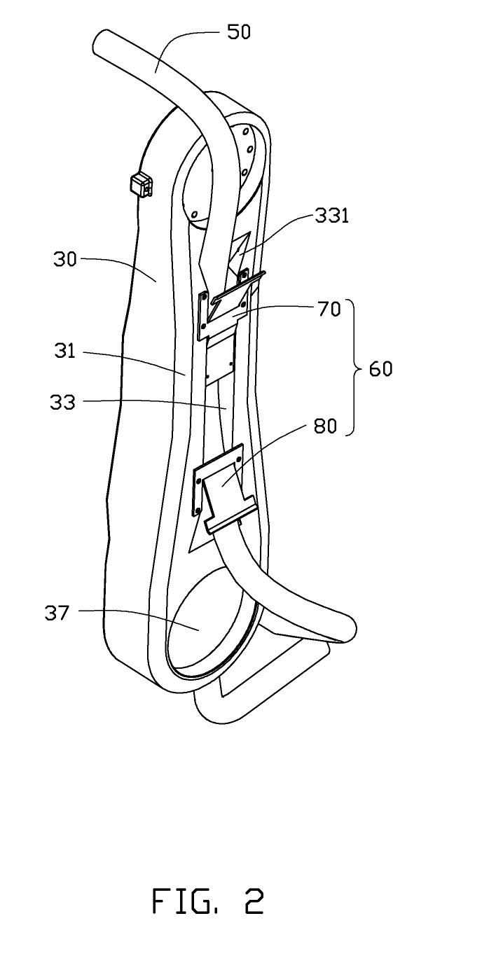

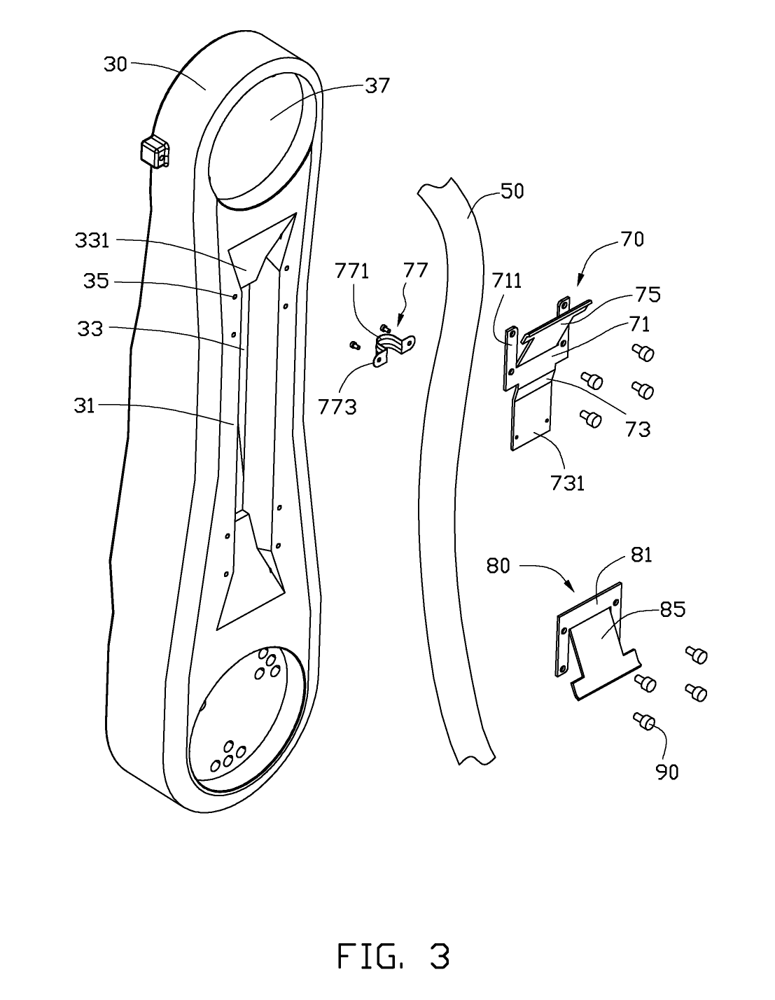

Also referring to FIGS. 2 and 3, the connecting arm 30 includes a mounting side surface 31, and a substantially rectangular cable receiving slot 33 recessed from the mounting side surface 31, longitudinally, for receiving the electric cable 50. Two ends of the cable receiving slot 33 are substantially inverted dovetail shaped, in the illustrated embodiment. Each end of the cable receiving slot 33 forms a slightly inclined guiding surface 331 connecting a bottom surface of the cable receiving slot 33 and the mounting side surface 31 together, thereby facilitating two ends of the electric cable 50 to exit from two ends of the cable receiving slot 33. The mounting side surface 31 of the connecting arm 30 further defines a plurality of mounting holes 35, adjacent to two sides of two ends of the cable receiving slot 33. In the illustrated embodiment, there are eight mounting holes 35, the eight mounting holes 35 are symmetrically positioned at two sides of the cable receiving slot 33 and adjacent to two ends of the cable receiving slot 33. Two substantially cylindrical assembling slots 37 are respectively defined in two ends of the mounting side surface 31 of the connecting arm 30.

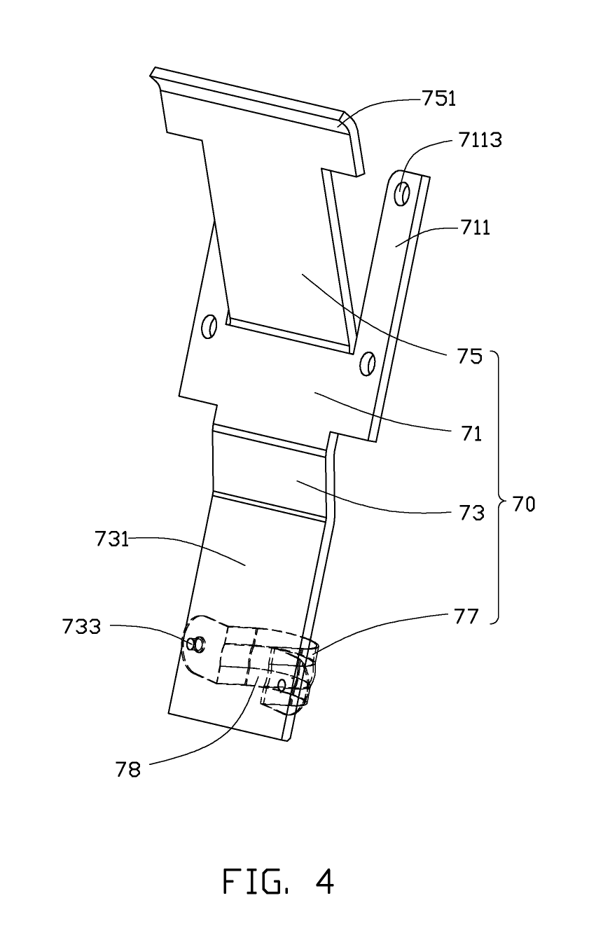

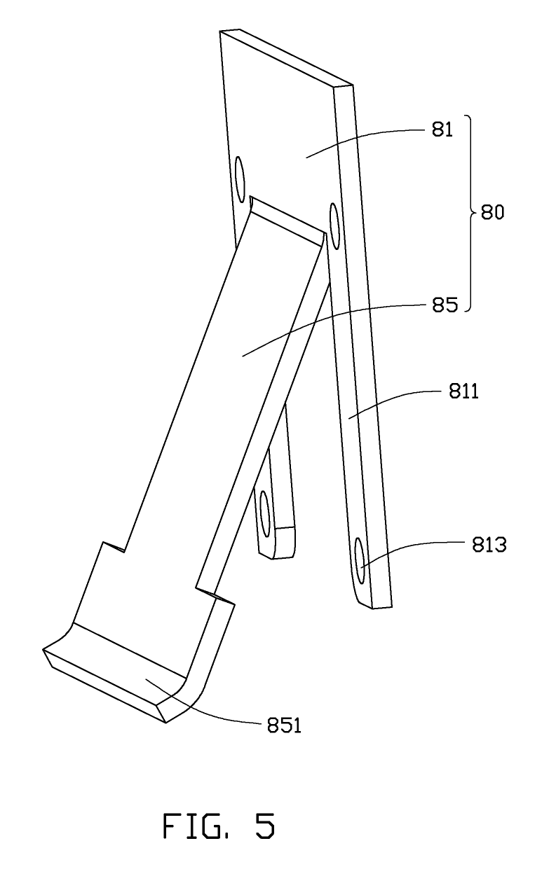

Also referring to FIGS. 4 and 5, the cable protection structure 60 includes a first positioning mechanism 70 and a second positioning mechanism 80. The first positioning mechanism 70 and the second positioning mechanism 80 are respectively fixed to two ends of the cable receiving slot 33 of the connecting arm 30 by a plurality of fixing members 90. In the illustrated embodiment, the fixing members 90 are screws.

The first positioning mechanism 70 includes a fixing member 71, a guiding member 73 extending from a first end of the fixing member 71, an elastic arm 75 extending from an opposite second end of the fixing member 71, and a positioning member 77. The fixing member 71 is substantially rectangular. Two fixing arms 711 extend from two sides of the second end of the fixing member 71, being parallel to each other, and are coplanar with fixing member 71. A plurality of fixing holes 7113 are defined through the two fixing arms 711 corresponding to the plurality of mounting holes 35 of the connecting arm 30.

The guiding member 73 is a substantially rectangular sheet, extending from the first end of the fixing member 71, away from the two fixing arms 711, and bending toward a first side of the fixing member 71. A substantially rectangular sheet shaped resisting portion 731 extends from a distal end of the guiding member 73, away from fixing member 71.

The elastic arm 75 extends out from a middle portion of the second end of the fixing member 71, and positioned between the two fixing arms 711. The elastic arm 75 is further bent toward a second side of the fixing member 71, away from the guiding member 73, and forms an acute angle with the two fixing arms 711. A substantially arc-shaped guiding portion 751 is formed at a distal end of the elastic arm 75, for decreasing a frictional force generated between the electric cable 50 and the elastic arm 75.

The positioning member 77 is detachably mounted on the resisting portion 731 of the guiding member 73 and positioned adjacent to a distal end of the resisting portion 731. The positioning member 77 includes a substantially U-shaped main portion 771 and two positioning portions 773 oppositely located at two ends of the main portion 771. When the positioning member 77 is mounted to the resisting portion 731, the two positioning portions 773 are fixed with the resisting portion 731, the main portion 771 of the positioning member 77 and the resisting portion 731 cooperatively define a cable passing hole 78 (as shown in FIG. 4) corresponding to the electric cable 50.

Referring to FIG. 5, the second positioning mechanism 80 includes a base body 81 and an elastic body 85 extending from one end of the base body 81. The base body 81 is a substantially U-shaped sheet having two fixing arms 811, and further defines a plurality of fixing holes 813 corresponding to the mounting holes 35 of the connecting arm 30. The elastic body 85 extends out from the base body 81, and positioned between the two fixing arms 811. The elastic body 85 forms an acute angle with the two fixing arms 811. The elastic body 85 further includes a substantially arc-shaped guiding portion 851 is formed at a distal end of the elastic body 85, for decreasing a frictional force generated between the electric cable 50 and the elastic body 85.

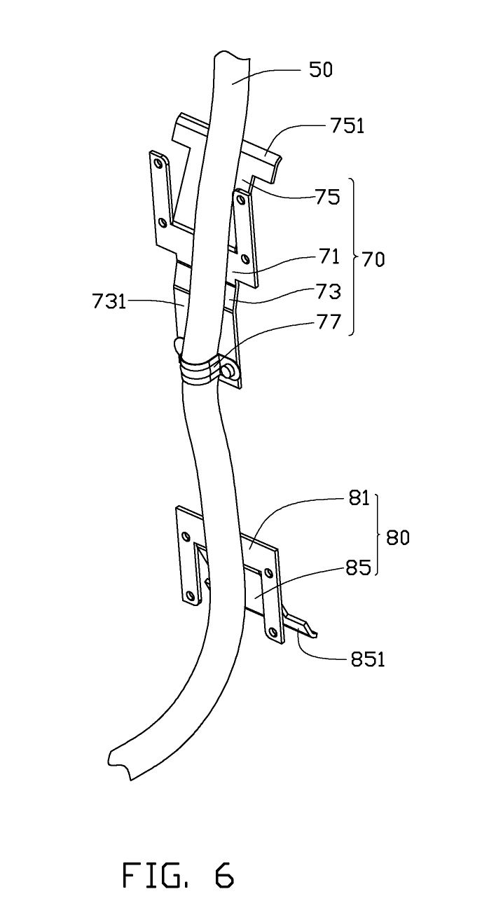

Referring to FIGS. 1 and 6, in assembly, the connecting arm 30 is firstly rotatably hinged to the base seat 10, and then the mechanical arm 40 is rotatably hinged to the distal second end of the connecting arm 30. The electric cable 50 is partially assembled into and received within the cable receiving slot 33 of the connecting arm 30, two ends of the electric cable 50 respectively exit from two ends of the cable receiving slot 33. The first positioning mechanism 70 and the second positioning mechanism 80 are oppositely fixed to two ends of the cable receiving slot 33 of the connecting arm 30 by the fixing members 90, and partially received within the cable receiving slot 33 to resist against the electric cable 50. The arc-shaped guiding portions 751 of the first positioning mechanisms 70 and a corresponding first end of the cable receiving slot 33 cooperative defines a first cable passing opening (not labeled). The arc-shaped guiding portions 851 of the second positioning mechanisms 80 and a corresponding second end of the cable receiving slot 33 cooperative defines a second cable passing opening (not labeled). Two ends of the electric cable 50 exit of the cable receiving slot 33 by respectively passing through the first and second cable passing openings, defined by the cable receiving slot 33 and the first and second positioning mechanisms 70, 80, and finally enter into the base seat 10 and the mechanical arm 40, respectively.

In one embodiment, the second positioning mechanism 80 has a substantially same shape and structure as that of the first positioning mechanism 70. The second positioning mechanism 80 can also be omitted.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A mechanical manipulator comprising:
a base seat;
a connecting arm having a first end rotatably hinged to the base seat, a second end that is opposite to the first end, and a side surface; and the connecting arm defines a cable receiving slot in the side surface;
a mechanical arm rotatably hinged to the second end of the connecting arm;
an electric cable partially received within the cable receiving slot, with two ends of the electric cable running out from the two ends of the cable receiving slot and entering the base seat and the mechanical arm; and
a cable protection structure fixed to the connecting arm and resisting against the electric cable toward the cable receiving slot, for preventing the electric cable emerging from the cable receiving slot.

2. The mechanical manipulator of claim 1, wherein the connecting arm comprises a mounting side surface, the cable receiving slot is recessed from the mounting side surface, two ends of the cable receiving slot are respectively located adjacent to the first end and the second end of the connecting arm; the cable protection structure comprises a fixing member and a guiding member extending from a first end of the fixing member, the fixing member is fixed to the mounting side surface, and the guiding member enters into the cable receiving slot and resists against the electric cable.

3. The mechanical manipulator of claim 2, wherein the two ends of the cable receiving slot are substantially dovetail shaped.

4. The mechanical manipulator of claim 2, wherein each end of the cable receiving slot forms a slightly inclined guiding surface, connecting a bottom surface of the cable receiving slot and the mounting side surface together, and thereby facilitating two ends of the electric cable running out from two ends of the cable receiving slot.

5. The mechanical manipulator of claim 4, wherein the cable protection structure further comprises an elastic arm extending from an opposite second end of the fixing member and being bent toward one side of the fixing member; the elastic arm faces toward a cable receiving slot first end, and cooperatively defines a cable passing opening with the cable receiving slot for facilitating one end of the electric cable passing therethrough.

6. The mechanical manipulator of claim 5, wherein the cable protection structure further comprises two fixing arms, that are parallel, extending from two sides of the second end of the fixing member, and the two fixing arms are coplanar with the fixing member and form an acute angle with the elastic arm.

7. The mechanical manipulator of claim 6, wherein the mounting side surface of the connecting arm further defines a plurality of mounting holes, adjacent to two sides of two ends of the cable receiving slot; the two fixing arms define a plurality of fixing holes corresponding to the plurality of mounting holes of the connecting arm; and the fixing member is fixed to the mounting side surface by a plurality of fixing members.

8. The mechanical manipulator of claim 6, wherein the elastic arm further comprises a substantially arc-shaped guiding portion formed at a distal end of the elastic arm, and the guiding portion is positioned adjacent to the cable passing opening for decreasing a frictional force generated between the electric cable and the elastic arm.

9. The mechanical manipulator of claim 5, wherein the guiding member is bent toward the other side of the fixing member, away from the elastic arm; and a resisting portion extends from a distal end of the guiding member; the cable protection structure further comprises a positioning member detachably mounted on the resisting portion, and the positioning member and the resisting portion cooperatively defines a cable passing hole facilitating the electric cable passing therethrough.

10. The mechanical manipulator of claim 9, wherein the positioning member comprises a substantially U-shaped main portion and two positioning portions oppositely located at two ends of the U-shaped main portion, the two positioning portions are fixed with the resisting portion, the main portion and the resisting portion cooperatively defines the cable passing hole.

11. A mechanical manipulator comprising:
a base seat;
a connecting arm having a first end rotatably hinged to the base seat, a second end that is opposite to the first end, and a side surface; and the connecting arm defines a cable receiving slot in the side surface;
a mechanical arm rotatably hinged to the second end of the connecting arm;
an electric cable partially received within the cable receiving slot, with two ends of the electric cable running out from two ends of the cable receiving slot and entering into the base seat and the mechanical arm; and
a cable protection structure fixed to the connecting arm and resisting against the electric cable toward the cable receiving slot, for preventing the electric cable emerging from the cable receiving slot;
wherein, the cable protection structure comprises a first positioning mechanism and a second positioning mechanism, the first positioning mechanism and the second positioning mechanism are oppositely fixed to two ends of the cable receiving slot of the connecting arm; the first positioning mechanism and the second positioning mechanism each form a cable passing opening with one corresponding end of the cable receiving slot, such that, two ends of the electric cable are capable of respectively passing through the two cable passing openings and further connected with the base seat and the mechanical arm.

12. The mechanical manipulator of claim 11, wherein the connecting arm comprises a mounting side surface, the cable receiving slot is recessed from the mounting side surface, two ends of the cable receiving slot are respectively located adjacent to the first end and the second end of the connecting arm; the first positioning mechanism comprises a fixing member fixed to the mounting side surface adjacent to one end of the cable receiving slot, and a guiding member extending from a first end of the fixing member, the guiding member enters into the cable receiving slot and resists against the electric cable; the second positioning mechanism comprises a base body fixed to the mounting side surface adjacent to the other end of the cable receiving slot, and an elastic body extending from one end of the base body, and the elastic body resists against the electric cable and forms an acute angle with the base body.

13. The mechanical manipulator of claim 12, wherein the two ends of the cable receiving slot are substantially dovetail shaped.

14. The mechanical manipulator of claim 12, wherein each end of the cable receiving slot forms a slightly inclined guiding surface connecting a bottom surface of the cable receiving slot and the mounting side surface together, thereby facilitating two ends of the electric cable running out from two ends of the cable receiving slot.

15. The mechanical manipulator of claim 14, wherein the first positioning mechanism further comprise an elastic arm extending from an opposite second end of the fixing member and being bent toward one side of the fixing member; the elastic arm faces toward one end of the cable receiving slot, and cooperatively defines the cable passing opening with the cable receiving slot for facilitating one end of the electric cable passing therethrough.

16. The mechanical manipulator of claim 15, wherein the first positioning mechanism further comprises two fixing arms parallely extending from two sides of the second end of the fixing member, the two fixing arms are coplanar with the fixing member, and the fixing member forms an acute angle with the elastic arm.

17. The mechanical manipulator of claim 16, wherein the elastic arm further comprises a substantially arc-shaped guiding portion formed at a distal end of the elastic arm, and the guiding portion is positioned adjacent to the cable passing opening for decreasing a frictional force generated between the electric cable and the elastic arm.

18. The mechanical manipulator of claim 16, wherein the guiding member is bent toward the other side of the fixing member, away from the elastic arm, a resisting portion extends from a distal end of the guiding member; the first positioning mechanism further comprises a positioning member detachably mounted on the resisting portion, and the positioning member and the resisting portion cooperatively defines a cable passing hole facilitating the electric cable passing therethrough.
